(19) United States
(12) Patent Application Publication
(10) Pub. No.: US 2014/0201099 A1
(43) Pub. Date: Jul. 17, 2014

(54) Continuity of instruction during a socially distancing event

(71) Applicant: Louis Harrison, Raleigh, NC (US)

(72) Inventor: Louis Harrison, Raleigh, NC (US)

(21) Appl. No.: 13/999,576

(22) Filed: Mar. 10, 2014

Related U.S. Application Data
(63) Continuation of application No. 12/801,156, filed on May 25, 2010.

(51) Int. Cl. G06Q 50/20; G06Q 10/00

(52) U.S. Cl. CPC G06Q 50/20; G06Q 10/00
USPC 705/326

(57) ABSTRACT

A method wherein live, in-person academic coursework that is cancelled for extended periods due to an exigency, for example a natural disaster, pandemic, or other socially distancing event, can be quickly, efficiently, gracefully, and cost-effectively transitioned into an online environment in order to ensure academic continuity by identifying a triggering event whereby in-person academic coursework is cancelled, initiating an academic continuity process, querying a student information system for data, interfacing this student information system data with a learning management system to populate the learning management system, simultaneously scaling the learning management system utilizing a cloud computing infrastructure, and transitioning the cancelled in-person academic coursework to an online environment.

### RELATED APPLICATIONS

This is a continuation application of U.S. patent application Ser. No. 12/801,156 filed May 25, 2010.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention relates to methods for ensuring academic continuity under exigent circumstances, for example a pandemic influenza outbreak. In particular, methods are disclosed whereby during a time of natural disaster, pandemic, or other socially distancing events during which traditional classroom sessions cannot be held, educational institutions' student information systems may be integrated with their online learning environments to facilitate the seamless transitioning of live instruction to the Web.

### BACKGROUND OF THE INVENTION

During periods of natural disaster, pandemic, or other devastating events, it is often necessary to close our educational institutions. With particular regard to universities, colleges, community colleges, and the like, these disruptions can result in dire consequences to the academic progress of their students, and in addition impact the institutions systemically or financially in the event that the interruption in class time is prolonged. Under these circumstances, transitioning curricula to an online presence will be important with regard to maintaining academic continuity.

In this age of global commerce, there is an ever increasing risk of contagion spreading uncontrollably amongst the populace. One need only look to recent outbreaks of swine influenza in the United States and avian influenza and the ebola virus elsewhere to understand that quelling the contagion usually requires isolating those already infected from those that are disease free and perhaps more importantly, those at greatest risk of becoming infected must be isolated from one another. During the recent H1N1 influenza outbreaks in the United States, numerous schools were closed. Extrapolating the same to a period of true pandemic infection, learning institutions may be closed as a precautionary measure for weeks, possibly months. Similarly, schools may simply be inaccessible during times of natural disaster. For example, in the wake of Hurricane Katrina, Tulane University® located in New Orleans was forced to close in August 2005, shortly after the beginning of its Fall Semester, and did not reopen until over four months later in January 2006. Its School of Medicine was unable to restart operations until July of that year, nearly a year after the storm. Fortunately, the Tulane diaspora was accommodated by other institutions around the United States. However, these students may have been better served had an online version of the classes they began just weeks earlier been available.

Distance education, distance learning, or “e-Learning” is now a well-known process by which the Internet is utilized to extend pedagogical activities beyond the traditional classroom. It facilitates off-site students' access to educational resources in instances where the source of instruction is separated by time, distance, or both. Historically, these applications were developed ad hoc by larger institutions for deployment within their own campuses and those of sister institutions. More recently, turnkey solutions have become available, for example, software suites available from Elluminate®, Wimba®, and Blackboard®, with the result that some form of distance education is available at essentially all post-secondary educational institutions and many of their K-12 counterparts. These Learning Management Systems (LMS) may be defined as software applications for the administration, documentation, tracking, and reporting of training and education programs, classroom and online events, distance learning programs, and training and educational content. They typically include both synchronous and asynchronous components. Synchronous distance learning simulates the live, in-classroom experience. Voice and/or text chat is available between the instructor and students, and the most sophisticated packages support multi-directional videoconferencing capability. These packages further include a shared whiteboard simulating the whiteboard/chalkboard at the front of every classroom whereby text or drawings written by the instructor are simultaneously displayed on the students' computer desktops. Asychronous distance learning may simply refer to archives of these aforedescribed synchronous classes that students can replay at their leisure. Additionally, asynchronous distance learning also refers to technologies permitting temporal separation whereby students can access coursework and interact at their convenience. In this mode, the instructor and students interact primarily through e-mail or message boards, with course materials posted online or downloaded and class assignments uploaded or e-mailed to the instructor.

However, while e-mail communication is now ubiquitous and instructors commonly post homework assignments online, outside of the few exclusively online institutions, relatively few courses are taught online. Due in part to a lack of will and academic resistance to changing the millennia old paradigm of in-person, live instruction, online courses are also comparatively expensive and resource intensive, requiring significant up front costs to purchase the necessary computer hardware and software, significant expenditures of time training users, and requiring a degree of computer support expertise that may be difficult to secure on smaller campuses. Moreover, in the case of classes which have traditionally been held in person, instructors often find it onerous to transition coursework they have previously delivered to actual classrooms of students into the virtual realm.

Nevertheless, during times of natural disaster, pandemic, or other socially distancing events, online or distance learning will likely be the only means to ensure continuity of instruction.

What is needed therefore is a means by which these previously “offline”, live courses can be quickly, efficiently, gracefully, and cost-effectively transitioned into an online environment in order to ensure educational continuity under exigent circumstances which prevent traditional classroom instruction, for example, a natural disaster, pandemic, or other socially distancing event. More specifically, replacing traditional classroom instruction under these circumstances requires that 1) all class information, including location, time and date, and enrollment be quickly identifiable, 2) integration of this information must occur in an automated manner with institutional LMS resources, and 3) sufficient resources must be available to support scaling LMS resources to the degree necessary. No known method exists for this process. However, all necessary information exists in institutional Student Information Systems (SIS), for example, those available from PeopleSoft®, Banner®, and the like. Information included in these SIS deployments include all pertinent class and student information, for example, the class name, number, the department to which it belongs, the time and days of the week and in which building it is scheduled to meet, its instructor, the students enrolled, e-mail addresses for everyone associated with the class, and the like.

### SUMMARY OF THE INVENTION

The present invention leverages existing student enrollment information already contained in institutional SIS infrastructure in conjunction with existing and/or prospectively provisioned LMS resources whereby, during periods of emergency, information from these aforementioned systems, for example, class, schedule, enrollment, and student data, may be used to populate LMS resources in order to facilitate the transitioning of previously live coursework to an online presence.

In a preferred embodiment, the method additionally includes leveraging a cloud computing or other distributed or cluster computing infrastructure to support necessary increases in LMS resource demand.

It is an object of this invention to provide means for continuity of education under exigent circumstances;

It is yet another object of this invention to interconnect technologies already available at most educational institutions to provide means for continuity of education under exigent circumstances;

It is still another object of this invention to provide a scalable means for continuity of education under exigent circumstances;

It is further an object of this invention to provide a scalable distance learning solution for continuity of education under exigent circumstances, including but not limited to pandemics and natural disasters;

It is an additional object of this invention to use existing institutional SIS and LMS resources whereby class and student information encoded in the SIS is leveraged to populate LMS resources to thereby transition live classroom content to an online realm during periods of emergency or similar exigencies; and,

It is also an object of this invention to use existing institutional resources in conjunction with existing or prospectively provisioned LMS and cluster or distributed computing resources to transition live classroom content to an online realm during periods of emergency or similar exigencies.

### BRIEF DESCRIPTION OF THE DRAWINGS

FIG. 1 is a block diagram of the present invention;

FIG. 2 is a block diagram showing the typical components of a Learning Management System; and,

FIG. 3 is a block diagram of a preferred embodiment of the present invention

### DETAILED DESCRIPTION OF THE INVENTION

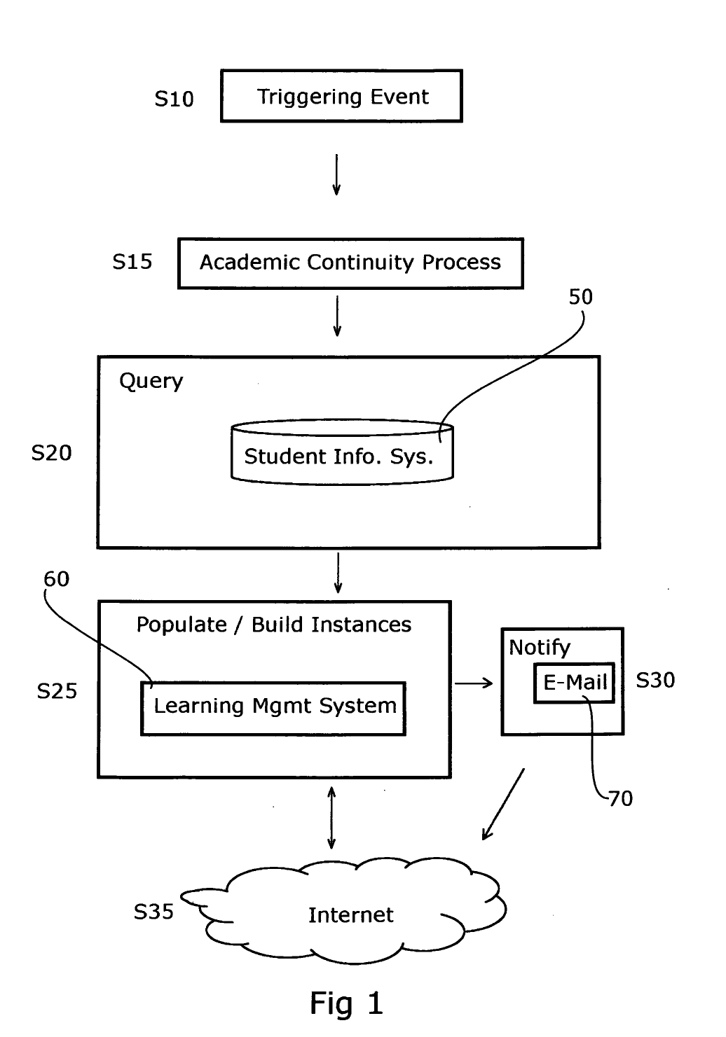

The preferred embodiment and best mode of the invention are shown in FIGS. 1 through 3. While the invention herein is described with regard to certain preferred embodiments, it is not intended that the present invention be so limited. On the contrary, it is intended to cover all alternatives, modifications, and equivalent arrangements as may be included within the spirit and scope of the invention as defined by the subsequent claims.

In accordance with the invention, FIG. 1 shows a diagrammatic representation of the present invention whereby a triggering event S10 occurs, for example a natural disaster, pandemic, or other similarly devastating occurrence during which in-person classroom sessions cannot be held. It is contemplated that most campuses will have contingency procedures in place such that the triggering event S10 will automatically set into motion its academic continuity process S15. Alternatively, the triggering event S10 may additionally require the intervention of an administrative entity, for example, the chancellor or president of an institution in order to activate the academic continuity process S15. Upon activation of process S15, a query operation S20 occurs whereby a datafeed from the student information system (SIS) 50 is secured in order to discern pertinent information regarding traditionally taught courses, including but not limited to the course name, number, and department; the dates, times, and locations it meets; and its instructor and enrolled students, including e-mail and similar contact information. The query operation S20 may further include business rules for coursework that cannot be held on line, for example physical education courses or wet laboratories, and the like. The data from said query S20 is subsequently used to populate/build instances S25 of each of the previously live classes on the institution's learning management system (LMS) 60 whereby the scheduled online sessions correspond with their analogous live, in-person sessions. It is contemplated that the sessions built on the LMS 60 will, in the great majority of cases, be synchronous sessions that are held at the same time and dates of their live counterparts and thereby most fully approximate the in-classroom experience. It is further contemplated that these sessions will be archived for later review. However, the invention additionally contemplates asynchronous sessions whereby the instructors and students are able to interact at their convenience. The aforementioned populate/build instances S25 step further includes creation of uniform resource locators (URLs) whereby in the subsequent notification S30 step the institution's e-mail process 70 is utilized to inform faculty that their classes now include an online presence in lieu of the cancelled live sessions. The e-mail may, in addition, include information regarding use of the technology, additional URLs to tutorials, and the like. Additionally, the e-mail may include instructions regarding opt out provisions, for example a URL to an opt out webpage, in the event the instructor had previously made alternative plans for continuity or otherwise elects not to attempt instruction online. Thereafter, classes are held via the Internet S35.

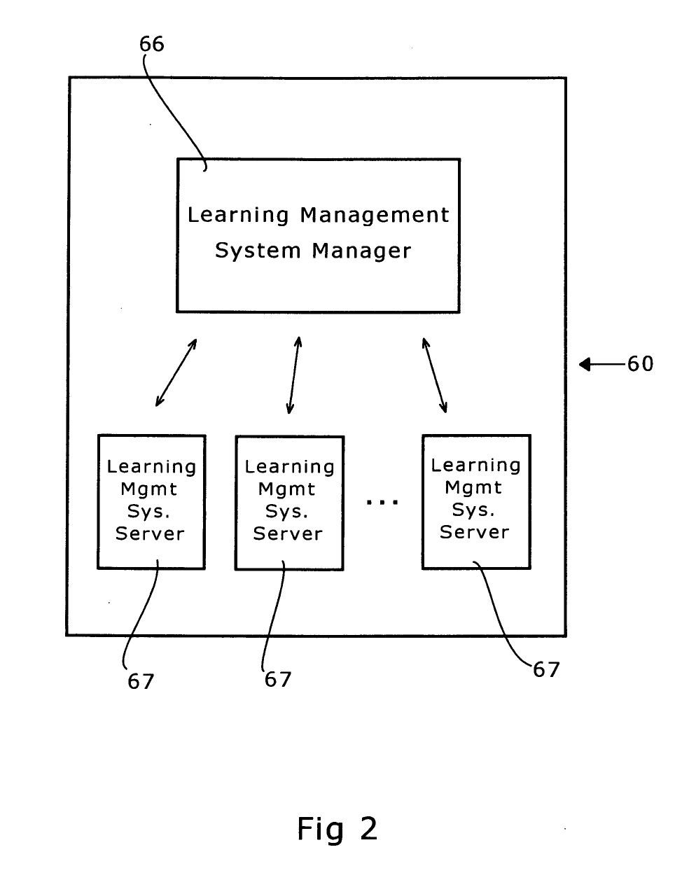

Turning now to FIG. 2, a diagrammatic representation of a typical LMS 60 is shown, for example, those available from Elluminate®, Wimba®, or Blackboard®. These systems typically include a management server 66, which in the present invention interacts with the SIS 50, and at least one physically separate and/or logically separate underlying content server 67. In instances whereby the LMS 60 cannot schedule to multiple servers 67, appropriate logic is included in the code deploying the LMS 60. It is contemplated that in the aforedescribed embodiment, the method of this invention utilizes unused or excess capacity available on the LMS 60 whereby additional capacity is maintained according to a prospective algorithm based, for example, on class size and the number of sessions occurring at any given time. Alternatively, additional resources may be maintained in reserve for use during exigent circumstances. In a preferred embodiment described in detail infra, it is contemplated that a distributed or cluster computing infrastructure, for example a cloud computing infrastructure be utilized to accommodate the additional resources required for the implementation of the present inventive method.

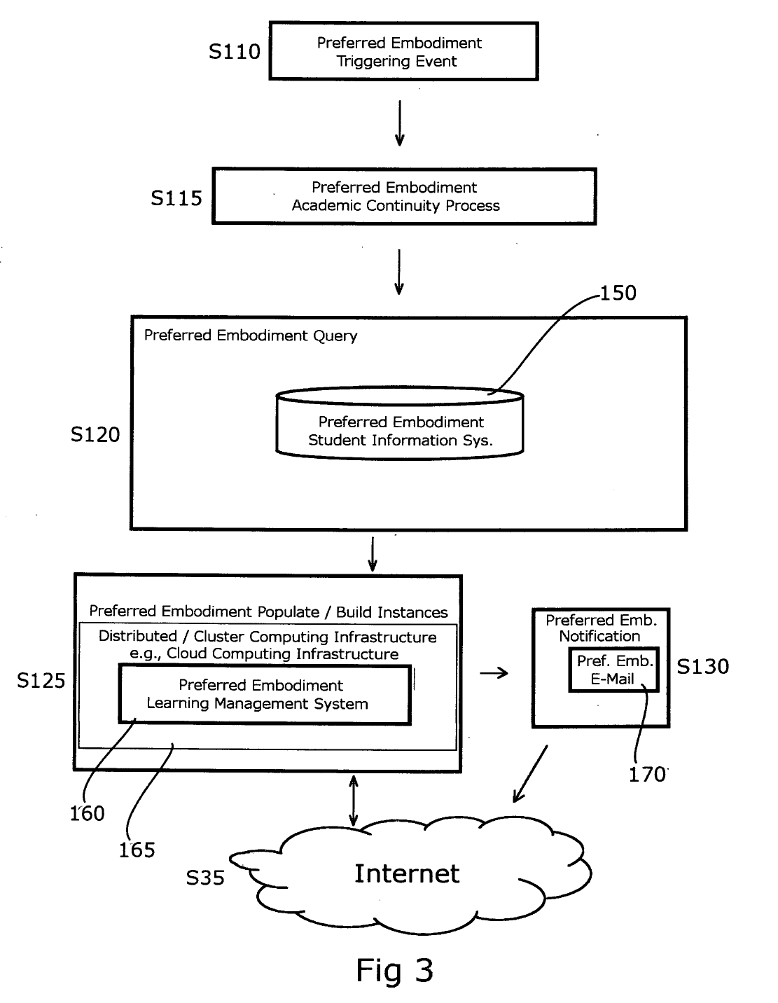

Turning to FIG. 3, a preferred embodiment is depicted whereby LMS 160 capacity is supported via a distributed or cluster computing infrastructure. The present invention contemplates any distributed or cluster computing infrastructure, for example Grid computing, Google MapReduce®, Apache Hadoop®, Amazon EC2® (Elastic Compute Cloud), 3tera AppLogic®, and the like. In this preferred embodiment, the distributed or cluster computing infrastructure 165 is a cloud computing infrastructure, namely the open source Apache Software Foundation® Virtual Computing Labe (VCL) environment whereby the system dynamically provisions and brokers remote access to a dedicated compute environment. The provisioned computers may be housed in a data center and may be physical blade servers, traditional rack mounted servers, or virtual machines. VCL may also broker access to standalone machines such a lab computers within the institution. Accordingly, because maintaining excess capacity for use only during exigent circumstances is generally not cost-effective, preferred embodiment populate/build instances S125 includes code to elastically reserve VCL capacity to run the services of the present inventive method.

In a fashion similar to that described supra, upon the occurrence of a preferred embodiment triggering event S110, the institution's preferred embodiment academic continuity process S115 commences whereby a preferred embodiment query process S120 occurs such that a datafeed from the preferred embodiment SIS 150 is secured in order to discern pertinent information regarding traditionally taught courses, including but not limited to the course name, number, and department; the dates, times, and locations it meets; and its instructor and enrolled students, including e-mail and similar contact information. The query S120 may further include business rules for coursework that cannot be held on line, for example physical education courses or wet laboratories, and the like. The data from said preferred embodiment query S120 is subsequently used with regard to preferred embodiment populate/build instances S125 of each of the previously live classes on the institutional preferred embodiment LMS 160 whereby the scheduled online sessions correspond with their analogous live, in-person sessions. All necessary instances of preferred embodiment LMS 160 are created ad hoc within a distributed or cluster computing infrastructure 165, for example, a cloud computing infrastructure, namely Virtual Computing Lab® (VCL). In this preferred embodiment, code is included to reserve necessary VCL resources, including by not limited to server blades, virtual machines, or lab machines to support any additional capacity required in the preferred embodiment LMS 160. It is further contemplated that said distributed or cluster computing infrastructure 165 may physically reside within the institution's communications network or be accessed remotely via a communications network 155, for example the Internet, a virtual private network, and the like. It is also contemplated that the sessions built on the preferred embodiment LMS 160 will, in the great majority of cases, be synchronous sessions that are held at the same time and dates of their live counterparts and thereby most fully approximate the in-classroom experience. It is further contemplated that these sessions will be archived for later review. However, this invention additionally contemplates asynchronous sessions whereby the instructors and students are able to interact at their convenience. The aforementioned preferred embodiment populate/build instances S125 step further includes creation of uniform resource locators (URLs) whereby in the subsequent preferred embodiment notification S130 step the institution's preferred embodiment e-mail process 170 is utilized to inform faculty that their classes now include an online presence in lieu of the cancelled live sessions. The e-mail may, in addition, include information regarding use of the technology, additional URLs to tutorials, and the like. Additionally, the e-mail may include instructions regarding opt out provisions, for example a URL to an opt out webpage, in the event the instructor had previously made alternative plans for continuity or otherwise elects not to attempt instruction online. Thereafter, classes are held via the Internet S35.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

1. A method for ensuring academic continuity comprising the steps of:
identifying a triggering event whereby in-person academic coursework is cancelled;
initiating an academic continuity process;
querying a student information system for data;
utilizing said student information system data with regard to dynamically provisioning resources and populating a learning management system;
transitioning essentially all of an institution's said in-person academic coursework to an online environment facilitated by said learning management system;
authenticating participants; and,
facilitating access to said online environment by said authenticated participants.

2. (canceled)

3. A method for ensuring academic continuity as claimed in claim 1 wherein said data from said student information system is data necessary to transition cancelled in-person academic coursework to an online environment further comprising class name, class number, department identification, class time, class daily schedule, class instructor, students enrolled, and e-mail addresses for everyone associated with said class.

4. A method for ensuring academic continuity as claimed in claim 1 wherein said learning management system is a synchronous learning management system.

5. A method for ensuring academic continuity as claimed in claim 1 wherein said learning management system is an asynchronous learning management system.

6. A method for ensuring academic continuity as claimed in claim 1 wherein said learning management system is a scalable learning management system whereby additional loads are accommodated utilizing cloud computing infrastructure means.

7. A method for ensuring academic continuity as claimed in claim 1 wherein said learning management system is a scalable learning management system whereby additional loads are accommodated utilizing distributed computing infrastructure means.

8. A method for ensuring academic continuity as claimed in claim 1 wherein said learning management system is a scalable learning management system whereby additional loads are accommodated utilizing cluster computing infrastructure means.

9. A method for ensuring academic continuity under exigent circumstances comprising the steps of:
identifying a triggering event whereby in-person academic coursework is cancelled;
initiating an academic continuity process;
querying a student information system for data;
interfacing said student information system data and a learning management system to populate said learning management system;
simultaneously dynamically provisioning resources and scaling said learning management system utilizing cloud computing infrastructure means; transitioning essentially all of an institution's said in-person academic coursework to an online environment
authenticating participants; and
facilitating access to said online environment by said authenticated participants.

10. (canceled)

11. A method for ensuring academic continuity under exigent circumstances as claimed in claim 9 wherein said data from said student information system is data necessary to transition cancelled in-person academic coursework to an online environment further comprising class name, class number, department identification, class time, class daily schedule, class instructor, students enrolled, and e-mail addresses for everyone associated with said class.

12. A method for ensuring academic continuity under exigent circumstances as claimed in claim 9 wherein said learning management system is a synchronous learning management system.

13. A method for ensuring academic continuity under exigent circumstances as claimed in claim 9 wherein said learning management system is an asynchronous learning management system.

14. A method for ensuring academic continuity under exigent circumstances comprising the steps of:
identifying a triggering event whereby in-person academic coursework is cancelled;
initiating an academic continuity process;
querying a student information system for data;
interfacing said student information system data and a learning management system to populate said learning management system;
simultaneously dynamically provisioning resources and scaling said learning management system utilizing cluster computing infrastructure means; and,
transitioning essentially all of an institution's said in-person academic coursework to an online environment.

15. A method for ensuring academic continuity under exigent circumstances as claimed in claim 14 wherein said data from said student information system is data necessary to transition cancelled in-person academic coursework to an online environment further comprising class name, class number, department identification, class time, class daily schedule, class instructor, students enrolled, and e-mail addresses for everyone associated with said class.

16. A method for ensuring academic continuity under exigent circumstances as claimed in claim 14 wherein said learning management system is a synchronous learning management system.

17. A method for ensuring academic continuity under exigent circumstances as claimed in claim 14 wherein said learning management system is an asynchronous learning management system.

18. A method for ensuring academic continuity under exigent circumstances comprising the steps of identifying a triggering event whereby in-person academic coursework is cancelled;
initiating an academic continuity process;
querying a student information system for data;
interfacing said student information system data and a learning management system to populate said learning management system;
simultaneously dynamically provisioning resources and scaling said learning management system utilizing a cloud computing infrastructure means; and,
transitioning entire institutional curricula to an online environment.

19. A method for ensuring academic continuity under exigent circumstances as claimed in claim 18 wherein said data from said student information system is data necessary to transition cancelled in-person academic coursework to an online environment further comprising class name, class number, department identification, class time, class daily schedule, class instructor, students enrolled, and e-mail addresses for everyone associated with said class.

20. (canceled)

21. (canceled)
